(19) United States
(12) Patent Application Publication
(10) Pub. No.: US 2006/0226374 A1
(43) Pub. Date: Oct. 12, 2006

(54) Method and device for identifying luminescent molecules according to the fluorescence correlation spectroscopy method

(75) Inventors: Rudolf Rigler, St. Sulpice (CH); Theo Lasser, St. Prex (CH); Pierre-Andre Besse, Ecublens (CH); Alexis Rochas, Lyon (FR); Alexandre Serov, Lausanne (CH); Michael Gosch, Stocksund (SE); Radivoje Popovic, Lausanne (CH)

Correspondence Address: ROTHWELL, FIGG, ERNST & MANBECK, P.C., 1425 K STREET, N.W., SUITE 800, WASHINGTON, DC, 20005, US

(73) Assignee: Gnothis Holding S.A., Lausanne-Ecublens (CH)

(21) Appl. No.: 10/567,427

(22) PCT Filed: Aug. 6, 2004
(86) PCT No.: PCT/EP04/08847

§ 371 Date: Feb. 6, 2006

Related U.S. Application Data
(60) Provisional application No. 60/492,724, filed on Aug. 6, 2003.

(30) Foreign Application Priority Data
Aug. 6, 2003 (DE) 103 36 080.8

(51) Int. Cl. G01J 1/58

(52) U.S. Cl. 250/458.1

(57) ABSTRACT

The invention relates to a method and device for identifying luminescent molecules according to the fluorescence correlation spectroscopy method. The inventive method comprising the following steps: a) preparing a sample (12) containing luminescent molecules; b) illuminating the sample (12) using an optical excitation device (2,4,6,8) comprising at least one light source, at least one, in particular, diffractive optical element (7) for splitting light passing therethrough into multiple beams, and a focusing optics (8) for focusing multiple light beams passing therethrough into multiple confocal volume elements: c) capturing emission radiation from the multiple confocal volume elements by means of a locally resolving sensor matrix arrangement (20), whereby the sensor matrix arrangement is a sensor matrix, which is comprised of avalanche photodiodes AD is produced using IC technology, particularly CMOS technology, and is integrated in a sensor chip (20) with Greiger-mode wiring, and; d) processing the signals, which are provided by the avalanche photodiode matrix, by means of a signal processing and evaluation device preferably integrated in the sensor chip.

The invention relates to a method for determining luminescent molecules by means of optical excitation in confocal measuring volumes, in particular the method of fluorescence correlation spectroscopy (FCS), comprising the steps of:
a) providing a sample comprising luminescent molecules,
b) irradiating the sample with an optical excitation device comprising at least one irradiation device for producing multiple beams and a focusing optics for focusing penetrating multiple light beams into multiple confocal volume elements,
c) capturing emitted radiation from the multiple confocal volume elements by means of a spatially resolving sensor matrix arrangement, and
d) processing the signals provided by the sensor matrix arrangement by means of a signal processing and evaluation device.

The invention likewise relates to a device for carrying out the method. A method and a device of the abovementioned type are known from WO 02/097406.

The methods and devices according to WO 02/097406 provide a simple way for a parallel determination of luminescent molecules in multiple confocal volume elements by means of fluorescence correlation spectroscopy. A spatially resolving detection matrix, for example assembled from individual avalanche photodiodes, serves as optical detection device.

Reference may further be made to EP 0679251 B1 for the prior art. EP 0679251 B1 sets forth principles of fluorescence correlation spectroscopy (FCS) of which use is also made in the method according to WO 02/097406 A1 and the present application. To this extent, the disclosure content of EP 0679251 B1 and WO 02/097406 A1 is also included in the content of the present application. Fluorescence correlation spectroscopy is used to determine substance-specific parameters that are ascertained by luminescence measurement at the analyte molecules. These parameters can be, for example, translation diffusion coefficients, rotation diffusion coefficients, the emission wavelength or/and the lifetime of an excited state of a luminescent molecule, or the combination of one or more of these measured variables. In particular, fluorescence correlation spectroscopy can be used to investigate chemical and photophysical dynamic properties of individual molecules (compare Rigler, R.; Elson, E. S.; “Fluorescence Correlation Spectroscopy, Theory and Applications”; Springer-Verlag: Berlin Heidelberg New York, 2001).

In a standard application of fluorescence correlation spectroscopy, the intensity fluctuations in the fluorescent signals of the molecules excited by light are measured, and an autocorrelation of this signal is performed. A very good signal-to-noise ratio is achieved by providing the confocal detection volume in the region of a pinhole diaphragm, it being possible for the confocal detection volume to be extremely small and, for example, to be in the femtoliter range and below.

Fluorescence correlation spectroscopy can be used, for example, in order to analyze molecular interactions, structural changes, chemical reactions, attachments to cell membranes, photophysical dynamic properties and transport and/or flow properties of molecules and/or samples.

One field of application for fluorescence correlation spectroscopy is so-called biochip microarray analysis. Biochips are available in different variants relating to the number of measurement site points. Thus, biochips having a few measurement site points are available, but so too are biochips which are provided with up to 100 000 measurement site points. The measuring time for examining or scanning a biochip microarray with the aid of confocal fluorescence correlation spectroscopy is directly proportional to the number of measurement points and can amount to a few hours. The time problem of parallel FCS detection of individual molecules cannot be solved by the use of CCD cameras with a few thousand detector elements, since CCD-based systems require a comparatively long readout time for the measurement results and therefore do not directly enable dynamic real time measurements (1 ns-1 ms). There is thus a need for a parallel (multiplex) measurement method having detector devices that react quickly, that is to say are quasi-real time capable, demand little space and are comparatively cost effective.

Starting from a prior art in accordance with WO 02/097406, it is the object of the invention to improve the possibility of quasi-parallel detection of luminescence events from a number of confocal volume elements.

The invention proposes for this purpose to make use as sensor matrix arrangement of a sensor matrix of avalanche photodiodes that is produced using IC technology, in particular CMOS technology or BICMOS technology, and is integrated in a sensor chip with Geiger mode wiring, for capturing the emitted radiation from the multiple confocal volume elements, wherein in accordance with a particularly preferred embodiment of the invention the sensor chip already includes integrated signal processing and evaluation circuits. These are, in particular, circuits for calculating correlation functions (autocorrelation or/and cross-correlation of various orders) as well as their Fourier transforms.

The sensor chip can have a multiplicity of avalanche photodiodes with Geiger mode wiring so that, if required, a corresponding number of confocal measuring volumes can be detected in parallel. Moreover, because of the IC integration, in particular CMOS integration of the photosensitive avalanche photodiodes, it is also possible to arrange that manufacturing tolerances of the individual photodiodes within the chip are comparatively slight, and thus that the individual integrated sensor elements have substantially the same detection properties. It has emerged from test measurements that an example of a CMOS sensor chip of the type considered here does not exhibit the effect, known from photomultipliers, of after-pulsing, and has a very small dark counting rate of approximately 40 Hz and a very short dead time of approximately 30 ns. The integrated avalanche photodiodes have a very high sensitivity and respond even to individual photons. They permit detection of individual molecules in the individual confocal volume elements considered using the FCS method.

The integration of electronic elements for the Geiger mode operation of the avalanche photodiodes and of signal processing and evaluation circuits, in particular correlators, permits extremely fast measurements and a quasi-real time measuring and evaluating operation.

Furthermore, it is possible in accordance with the present invention to carry out time-resolved measurements of fluorescence, and thus to conduct time-correlated spectroscopy.

The irradiation device preferably comprises at least one light source and at least one, in particular diffractive, optical element for splitting penetrating light into multiple beams. Alternatively, consideration is given to, for example, reflective beam splitters, for example semireflective mirrors, for beam splitting.

Furthermore, the irradiation device can comprise a light source array, in particular laser array or VCSEL array, that already originally provides multiple beams.

The method can be carried out in principle using the method described in EP 0679251 B1 or in WO 02/097406. It is preferable to measure one or a few analyte molecules in a measuring volume, the concentration of the analyte molecules to be determined preferably being less than 10⁻⁶ mol/l, and the measuring volume preferably being smaller than 10⁻¹⁴ l. Substance-specific parameters are determined that are ascertained by luminescence measurement on the analyte molecules. Reference may be made to the disclosure in EP 0679251 B1 and WO 02/097406 for details relating to equipment.

In particular, the inventive method can be carried out in accordance with the method of WO 02/097406 to the extent that in preferred refinements of the method the luminescent molecules are selected from luminescence-labeled detection reagents which are attached to an analyte present in the sample. Again, the method according to the invention can comprise the measurement and/or determination of a cross correlated signal that originates from a complex, including at least two different luminescence labelings, composed of analyte reagent(s) and detection reagent(s).

The molecular determination can comprise the measurement of a signal originating from a luminescence-labeled detection reagent, the luminescence intensity or/and luminescence decay time of the detection reagent differing for attachment to the analyte from the luminescence intensity or/and decay time in the unattached state. The differences of the luminescence intensity or/and luminescence decay time can be caused in this case by quenching or energy transfer processes.

The molecular determination according to the inventive method can further comprise a nucleic acid hybridization, one or more luminescence-labeled probes attaching to a target nucleic acid.

The molecular determination can comprise a protein/antibody interaction, the antibodies being able to emit at different optical wavelengths (colors). The signals are then subjected to cross-correlation during signal processing.

In a further aspect, the molecular determination can comprise an enzymatic reaction.

In a further aspect, the molecular determination can comprise a nucleic acid amplification, in particular a thermocycling process.

In a further aspect, the molecular determination can comprise a mutation analysis for nucleic acids.

In a further aspect, the molecular determination can comprise a gene expression analysis for nucleic acids.

In a further aspect, the molecular determination can comprise the measurement of a temperature-dependent melting curve for a nucleic acid hybridization.

In a further aspect, the molecular determination can comprise a particle selection.

In a further aspect, the molecular determination can comprise a nucleic acid sequencing.

In accordance with one embodiment, the carrier used can contain a number of, in particular at least ten and preferably at least 32, separate containers for holding samples.

Alternatively, the sample can be provided in a microchannel structure, an analyte present in the sample preferably being retained in the microchannel structure.

In a further aspect, it can be provided that an analyte present in the sample is subjected to a splitting reaction wherein fragments split off from the analyte are determined.

The analyte present in the sample can be coupled to a carrier particle, for example made from plastic, glass, quartz, metal or composite material.

In very general terms, the method according to the invention can be applied in order to determine luminescent molecules, in particular individual molecules, from an individual sample in the various confocal measuring volumes—or from various samples in the confocal measuring volumes. The parallel detection of the luminescence events in a number of detection volumes further permits the determination of the local flow velocity (velocity profile) in a microchannel.

The method also permits the determination of individual molecules in a flow. Again, a number of measurement-points can be detected in a sample volume by a number of sensor elements, it being possible thereby to increase the probability of detection in strongly diluted measurement samples.

The device proposed according to the invention for determining luminescent molecules by means of optical excitation in confocal measuring volumes comprises:
a) a carrier arrangement for holding a sample that contains molecules to be determined,
b) an optical excitation device that can provide multiple light beams, and has, in particular, at least one diffractive optical element for splitting penetrating light into multiple beams, and a focusing optics for focusing penetrating multiple light beams into multiple confocal volume elements in the respective measuring volume for the purpose of exciting luminescence in the multiple confocal volume elements,
c) an optical detection device for detecting luminescence from the confocal volume elements, the optical detection device comprising a spatially resolving sensor matrix of avalanche photodiodes that is produced using IC technology, in particular CMOS technology, and is integrated in a sensor chip with Geiger mode wiring, for capturing emitted radiation from the multiple confocal volume elements, and
d) signal processing and evaluation means for processing the signals provided by the avalanche photodiode matrix.

As already mentioned above, it is advantageous when the signal processing and evaluation means are integrated in the sensor chip in order to be able to carry out quasi-real time measurements.

Consideration is given to correlators for autocorrelation determinations or/and, if appropriate, cross-correlation determinations as integrated signal processing and evaluation means. Circuits for carrying out fast Fourier transforms of the measuring signals can be provided as signal processing and evaluation means, and be integrated in the sensor chip. In a preferred refinement of the invention, the correlator circuits can execute correlation operations using the “multiple tau or multiple Σ” principle. For the multiple tau technique, reference may be made, for example, to Schatzel, K., “Correlation Techniques in Dynamic Light Scatteing”, Journal of Applied Physics B, 1987, pages 193-213, Schatzel, K., “New Concepts in Correlator Design”, Proc. of the int. Phys. Conference, Ed. E. Hilger, 1985, Ser. 77, pages 175-184, Peters, R., Introduction to the Multiple Tau Correlation Technique, ALV GmbH, 1996, Schatzel, K., Drewel, M., and Stimac, S. “Photon Correlation Measurements at large Lag Times: Improving the Statistical Accuracy”, Journal of Modern Optics, vol. 35, No. 4, 1998, pages 711-718.

A laser preferably comes into consideration as light source. It is preferred to make use as diffractive optical element for beam splitting of a three-dimensional optical grating that diffracts penetrating light and produces a predetermined diffraction pattern comprising multiple optical foci. In accordance with one embodiment of the device according to the invention, the carrier has a number of, preferably at least ten, in particular at least 100, separate containers for holding samples.

In accordance with another refinement, the carrier can have a microchannel structure with one or more channels.

Furthermore, the subject matter of the present invention is the use of a CMOS sensor chip with integrated avalanche photodiodes with Geiger mode wiring for a parallel determination of molecular interactions in multiple confocal volume elements, in particular in a method of fluorescence correlation spectroscopy.

The invention is explained in more detail below with reference to the figures, in which:

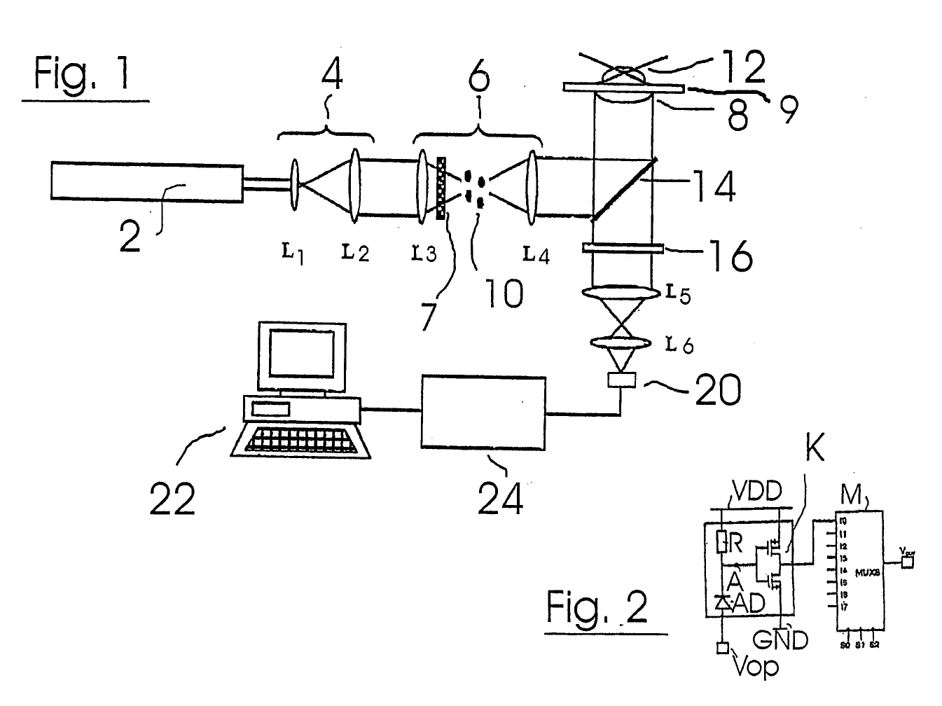

FIG. 1 shows a schematic of an exemplary embodiment of a device according to the invention,

FIG. 2 shows a schematic of a preferred example for the wiring of an avalanche photodiode pixel in the sensor chip, and

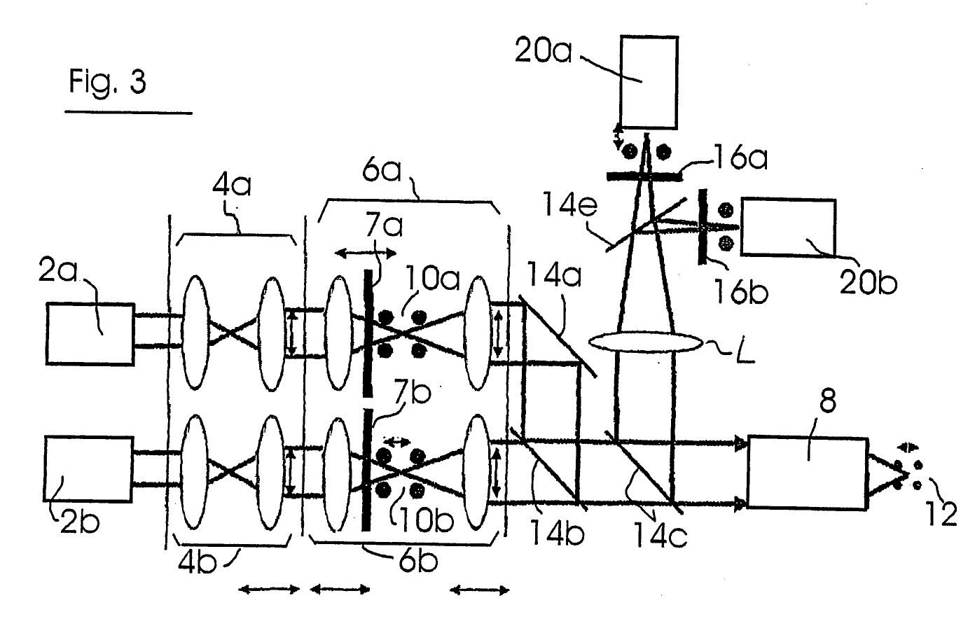

FIG. 3 shows a schematic of a further exemplary embodiment of a device according to the invention.

In the exemplary embodiment of a device according to the invention that is shown in FIG. 1, the light source is provided as a diode-pumped solid-state laser that emits at an optical wavelength of 532 nm and whose laser beam is expanded by the beam expanding optics 4 with the optical elements L1 and L2, such that it essentially illuminates the diffractive optical element 7 completely. The expanded laser beam is split into a pattern of multiple foci by using the collimator 6 with the optical elements L3 and L4 and the microscope objective 8, and is focused in the sample (liquid drops) at 12. The confocal volume elements in the sample volume that are illuminated by the focused partial beams are not shown in detail in FIG. 1. Denoted by 14 in FIG. 1 is a dichroic mirror that reflects the excitation light into the microscope objective 8 and thus toward the sample. The fluorescence emission emanating from the excited molecules in the confocal volumes is collected via the same objective 8 such that it passes through the dichroic mirror 14 to a bandpass filter 16. The bandpass filter discriminates the signal light from the Rayleigh scattered light and Raman scattered light. The fluorescence emission light is then directed onto the sensor chip 20 through the lens group L5 and L6. The sensor chip 20 is a CMOS chip with an integrated array of avalanche photodiodes with Geiger mode wiring. Also integrated are electronic components for operating the avalanche photodiodes and for signal processing, for example quench resistors, transistors, correlators and arithmetic circuits for further signal processing operations. The sensor chip 20 is read out by a computer 22, it being possible for any external evaluation components 24 to be inserted between the computer 22 and the sensor chip 20.

The sample area 12 is illustrated in the exemplary embodiment according to FIG. 1 as drops on a microscope cover glass 9.

When the device is used to carry out a high throughput screening method, consideration is given as the appropriate sample carrier 9 to, in particular, a microarray structure having a relatively large number of separate sample containers, for example 100 or more separate sample containers, which are formed by depressions in a plate. When the number of the containers inside the carrier is greater than the number of the partial beams generated by the diffractive optical element, the carrier can be scanned in a number of steps. To this end, the optics or/and the carrier can respectively be readjusted by means of suitable measures for the individual steps.

A carrier with microchannels for the sample material can be used for other measurement tasks, for example for single molecule sequencing or for single molecule selection.

FIG. 2 shows the electric components of a CMOS photodiode pixel schematically and by way of example. The anodes of all the avalanche photodiodes AD are biased with a high negative voltage VOP of, for example, −18.5 V. The remaining region of the CMOS chip is located electrically at the potential between ground GND and the supply voltage VDD of, for example, 5 V.

A pixel comprises a, for example, circular avalanche photodiode for individual photon detection, and a quench resistor R of, for example, 270 kΩ, which is connected in series between the cathode of the avalanche photodiode AD and the supply voltage VDD. The breakdown voltage of the diode AD is, for example, 21 V. The diode AD is therefore biased with a voltage value of 2.5 V above the breakdown voltage.

Furthermore, a simple comparator K based on a standard inverter is implemented at each pixel location. The configuration of the transistors permits the input threshold voltage for switching over to output to be set to 3 V. As long as no charge carriers reach the multiplication region of the diode AD, no current flows into the photodiode AD. The avalanche effect is triggered when a photon strikes the photodiode AD. The avalanche current simultaneously discharges the diode capacitance (and parasitic capacitances at the point A) and induces a voltage drop across the resistor R. The voltage across the diode AD becomes smaller. The voltage at the node A changes from 5 V to 2.5 V. The comparator output is therefore switched to VDD. The avalanche current is passively quenched in a few nanoseconds. The recharging process with a time constant of approximately 30 ns starts thereafter.

A dead time of approximately 32 ns was measured for the sensor element. During the discharging, the voltage rises at the node A from 2.5 V to VDD. The comparator output is switched to ground GND. The output of the comparator K is connected to an input of the multiplexer shown at M and whose other inputs are occupied by other pixel elements of the sensor array, and which is a constituent of a simple addressing circuit. The multiplexer components N are preferably integrated in the sensor chip 20. Instead of the quench resistor R, it is possible in an alternative embodiment of the pixels to provide a transistor operating in the saturation region.

In one exemplary embodiment of the sensor chip 20, the photosensitive region of a respective avalanche photodiode is approximately 30 μm². Further miniaturization is possible.

FIG. 3 shows a schematic of the design of a further exemplary embodiment of a device according to the invention. Elements in FIG. 3 that correspond to elements in FIG. 1 in terms of function are denoted by corresponding reference numerals, the letters a and b being appended to the reference numerals for the purposes of further differentiation in FIG. 3.

The exemplary embodiment according to FIG. 3 is suitable, in particular, for cross-correlation measurement when the sample is irradiated with multiple beams of different excitation wavelengths, and permits a better detection specificity of biomolecules. It is possible to measure very accurately with high sensitivity, since only biomolecules with twofold dye labeling are considered in the cross-correlation operation.

In the case of such a dual color cross-correlation analysis, the dyes are excited in the case of the example by means of two different laser wavelengths. A two-photon excitation is also possible.

In the case of the example of FIG. 3, a first laser 2a, for example an argon laser, and a second laser 2b, for example a helium-neon laser, are provided as radiation sources. Following in the optical beam lengths of these light sources are a respective beam expanding optics 4a or 4b, and the collimators 6a or 6b, each having a diffractive optical element 7a, 7b for the purpose of splitting the expanded laser beams into a respective pattern of multiple foci 10a, 10b. The partial beams are directed to the sample 12 by means of the mirrors 14a, 14b such that they are focused into confocal volume elements in the sample region. The relevant microscope objective is provided at 8.

The emitted radiation emanating from the excited molecules in the confocal volumes is collected via the objective 8 such that it passes from the dichroic mirror 14c through the lens L to the beam splitter (dichroic mirror) 14e. The partial beams passed on by the beam splitter 14e pass through the bandpass filter 16a or 16b to the avalanche diode sensor chips 20a and 20b respectively, with integrated evaluation electronics. The control and evaluation computer, which receives information from the elements 20a, 20b, is not illustrated in FIG. 3.

It remains to add that the partial beams of different wavelengths in the sample region 12 can be superimposed on one another in relevant confocal volumes. Two different dyes that are provided as labels on one and the same molecule can then simultaneously emit bichromatic fluorescent light when the molecules traverse the measuring volume of the foci superimposed on one another. The relevant signals of the various wavelengths can then be subjected to cross-correlation in order, for example, to acquire information relating to the number of doubly labeled biomolecules in a sample volume, etc.

1. A method for determining luminescent molecules by means of optical excitation in confocal measuring volumes, in particular the method of fluorescence correlation spectroscopy (FCS), comprising the steps of:
a) providing a sample (12) comprising luminescent molecules,
b) irradiating the sample (12) with an optical excitation device (2, 4, 6, 8) comprising at least one irradiation device for producing multiple beams and a focusing optics (8) for focusing penetrating multiple light beams into multiple confocal volume elements,
c) capturing emitted radiation from the multiple confocal volume elements by means of a spatially resolving sensor matrix arrangement (20), the sensor matrix arrangement being a sensor matrix of avalanche photodiodes AD that is produced using IC technology, in particular CMOS technology, and is integrated in a sensor chip (20) with Geiger mode wiring, and
d) processing the signals provided by the avalanche photodiode matrix by means of a signal processing and evaluation device that is preferably integrated in the sensor chip.

2. The method as claimed in claim 1, characterized in that an irradiation device having at least one light source and at least one, in particular diffractive, optical element is used for splitting penetrating light into multiple beams.

3. The method as claimed in claim 1 for carrying out fluorescence correlation spectroscopic examinations on luminescent molecules, the signal processing comprising the steps of autocorrelation or/and cross-correlation or/and fast Fourier transform (FFT) of measuring signals or information derived therefrom.

4. The method as claimed in claim 3, in which correlation steps of various correlation orders are carried out for signal evaluation.

5. The method as claimed in claim 3, in which the signal processing comprises correlation steps using the one-bit method or/and correlation steps using the 4×4-bit method.

6. The method as claimed in claim 1, in which the signal processing comprises correlation steps using the multi-τ method.

7. A device for determining luminescent molecules by means of optical excitation in confocal measuring volumes, in particular for carrying out the method as claimed in claim 1, comprising:
a) a carrier arrangement (9) for holding a sample (12) that contains molecules to be determined,
b) an optical excitation device (2, 4, 6, 8) for providing multiple light beams and, in particular, comprising at least one light source (2), at least one passive or active diffractive optical element (7) for splitting penetrating light into multiple beams, and a focusing optics (8) for focusing penetrating multiple light beams into multiple confocal volume elements in the respective measuring volume for the purpose of exciting luminescence in the multiple confocal volume elements,
c) an optical detection device (20) for detecting luminescence from the confocal volume elements, the optical detection device comprising a spatially resolving sensor matrix of avalanche photodiodes AD that is produced using IC technology, in particular CMOS technology, and is integrated in a sensor chip (20) with Geiger mode wiring, for capturing emitted radiation from the multiple confocal volume elements, and
d) signal processing and evaluation means for processing the signals provided by the avalanche photodiode matrix (20).

8. The device for determining luminescent molecules as claimed in claim 7, in which the signal processing and evaluation means are integrated in the sensor chip (20).

9. The device for determining luminescent molecules as claimed in claim 7, in which the signal processing and evaluation means comprise at least one correlator, preferably a number of correlators, for carrying out signal correlation operations, in particular for determining autocorrelation functions or/and cross-correlation functions of first or/and higher correlation orders of measuring signals.

10. The device for determining luminescent molecules as claimed in claim 7, in which the signal processing and evaluation means comprise circuits for carrying out a fast Fourier transform of the measuring signals.
